(19) United States
(12) Patent Application Publication
(10) Pub. No.: US 2009/0307379 A1
(43) Pub. Date: Dec. 10, 2009

(54) ELECTRONIC APPLIANCE, PARTICULARLY AN ETHERNET SWITCH, HAVING MEANS FOR RELIABLE REMOTE MAINTENANCE

(76) Inventor: Dirk Mohl, Esslingen (DE)

Correspondence Address: K.F. ROSS P.C., 5683 RIVERDALE AVENUE, SUITE 203 BOX 900, BRONX, NY, 10471-0900, US

(21) Appl. No.: 12/306,257

(22) PCT Filed: Jun. 20, 2007
(86) PCT No.: PCT/EP07/05426

§ 371 Date: Mar. 12, 2009

(30) Foreign Application Priority Data
Jun. 23, 2006 (DE) 102006029343.6

(51) Int. Cl. G06F 3/00; G06F 12/00

(52) U.S. Cl. 710/8; 711/167; 711/E12.001

(57) ABSTRACT

The invention relates to an electronic appliance having at least one control unit and at least one memory unit and also to an appropriate method, the appliance having an operating system with a piece of software in a particular configuration for operation of the appliance, where the invention provides for the appliance to have an interface to which means for remote maintenance of the appliance are connected and for the appliance to have a timer, the timer starting to run in the event of a configuration change and stopping only as soon as a changed configuration has been loaded into the memory unit correctly and then the appliance is operated using the changed and correctly stored configuration.

The invention relates to an electronic device having at least one controller and at least one memory, the device further having an operating system with software in a particular configuration for operation of the device according to the characteristics of the generic part of patent claim 1.

The invention is related to known electronic devices (hardware) having an operating system containing software in a particular configuration for operation of the device. In particular, the invention relates to switches, preferably Ethernet switches, used under particular environmental conditions, such as on the ocean, in mines, in tunnels, in production facilities, or the like.

If configurations of the software are carried out on such an electronic device by an operator (such as the administrator) according to the known current state, then the configurations (such as an update of a software, or also completely new software replacing the currently stored software) will always become active immediately. A configuration change is always initially performed in memory, preferably a volatile main memory. For this purpose the new configuration is locally (e.g. where the device is installed) stored in the memory thereof, all configuration information being transferred to the memory, for example, to the local, non-volatile memory (flash memory).

However, devices, particularly Ethernet switches, for particular environmental conditions, are often installed and operated at locations (installation sites) that are accessibly only with great difficulty and expense. Therefore it has generally been known that the device may be configured remotely from a control center to which the device is connected.

In this type of configuration, however, it may occur that the device is no longer available due to an error, particularly a configuration error, or an error that occurred during data transfer. This means that according to the prior art the generally functional configuration in a certain version (possibly also the initial version) is replaced with the changed configuration such that the currently existing and correctly functioning configuration can no longer be utilized due to the replacement by the new configuration, because it is assumed that it is being replaced by correct installation of the new configuration, and that the device will subsequently be operational using the new configuration. However, as described this known configuration change has the disadvantage that the device can no longer be further operated, if the new configuration was not properly installed, or errors occurred during the data transfer, since the software currently running on the device has been, for example, partially or even completely deleted with the beginning of the new configuration. Although electronic devices have a so-called reset button (or other possibilities in order to enable a restart) for such a case, it use requires that the non-operational state now can only be removed from the device on site. Depending on the installation site, however, this may be possible only with a high degree of difficulty, for example, if electronic devices are used in offshore wind power plants, controlling or regulating the operation of the wind power plant. In this case it is necessary to manage such an offshore wind power plant by means of ship or helicopter, which, however, results in a high expense of time and money.

It is also known to utilize networks in production facilities or process technical plants for controlling the processes at these locations, switches or the like being used in this network as the electronic device for controlling the data and information flow. In this case failure of an electronic device, particularly in the case of time-critical production or process technical processes, also results in a high costs until an operator has reached the installation site of the device and is able to perform a restart.

The object of this invention is therefore to provide an electronic device in which a configuration change can be carried out remotely and reliably without any problems, while avoiding the disadvantages described above.

This object is attained by the characteristics of patent claim 1.

The invention provides that the device has an interface, to which a means for remote maintenance of the device is connected, and that the device has a timer, the timer being set to run in the event of a configuration change and stop only after a changed configuration has been loaded into the memory correctly, and then the device is operated using the changed and correctly stored configuration.

The prerequisite for realizing such an electronic device is an interface via which the device is connected to a control center at a distance in a wired or wireless manner. In this manner it is generally possible that the operator (such as the administrator or a service technician) no longer has to be present at the installation site of the electronic device for the purpose of a configuration change, but may carry out the configuration change from a distance (such as several hundreds of meters, but also via distances of several kilometers), preferably from a control center, instead. Such a control center may be a control room, for example in the case of a production facility or of a technical process, a laptop having a radio connection to the electronic device as the control center also being conceivable.

The devices according to the invention (particularly the switches) have a special function for this type of application, which is realized using respective means. If same are activated, the following method is carried out and the device (the switch) responds as follows:

As soon as any configuration change (initial configuration, or for example, an update) starts being carried out in the device within the course of remote maintenance, a timer present in the device starts for a time duration of, for example, 30 minutes. The time duration may also be longer or shorter than 30 minutes. The time duration may also be changed, preferably via remote maintenance. Preferably, this depends on the expected duration of the transmission and storage of the configuration data. With each further configuration change (e.g. data flow to the device containing the configuration data) the timer begins to run again. Therefore, the timer does not expire as long as configuration changes are carried out. The timer stops after the current configuration (configuration data) has been stored locally in the memory of the device, and restarts after a further configuration change is carried out. The expiration of the time may be prevented in that communication is established between the remote device (switch) and the configuration surface. If the timer expires after the configuration data has been transferred and loaded correctly, this stored and correct configuration is loaded. This function according to the invention now enables that in case of any misconfiguration the device is again accessible after expiration of the timer. This action is therefore ensured, since the last stored configuration is either the default configuration or a configuration, in which a functioning communication was possible (for example, for initiating the memory process).

The invention therefore relates to an electronic device, particularly an Ethernet switch, and a respective method for particular environmental conditions, using at least one memory for storing operating software at a current configuration, and having a means for remote maintenance of the device, at least for transferring and storing a new configuration (such as the configuration data thereof), wherein the device comprises the function and related means to continue to operate in case of a malfunction during remote maintenance leading to the non-availability of the device after expiration of a certain time using the previous (current) configuration, if the intended new configuration has failed for any reason.

1. An electronic device having at least one controller and at least one memory, the device having an operating system with software in a particular configuration for operation of the device wherein the device has an interface to which a means for remote maintenance of the device is connected and having a timer that starts to run in the event of a configuration change and stops only after a changed configuration has been loaded into the memory correctly, the device then being operated using the changed and correctly stored configuration.

2. The electronic device according to claim 1 wherein the device is an Ethernet switch.

3. The electronic device according to claims 1 wherein the means for remote maintenance is a control center, the device being connected to the control center from a distance via cables.

4. The electronic device according to claims 1 wherein the means for remote maintenance is a control center, the device being connected to the control center from a distance in a wireless manner.

5. The electronic device according to claim 4 wherein the wire connection is a radio or infrared connection.

6. The electronic device according to claim 1 wherein the device is in a network.

7. The electronic device according to claim 6 wherein the network is an Ethernet network.
